(19) United States
(12) Patent Application Publication
(10) Pub. No.: US 2008/0283188 A1
(43) Pub. Date: Nov. 20, 2008

(54) FERRITE PASTE, AND METHOD FOR MANUFACTURING LAMINATED CERAMIC COMPONENT

(75) Inventors: Kunio ODA, Tokyo (JP); Naoki SUTOH, Tokyo (JP); Yukio TAKAHASHI, Tokyo (JP); Kunihiko KAWASAKI, Tokyo (JP); Hiroshi MOMOI, Tokyo (JP)

Correspondence Address: OLIFF & BERRIDGE, PLC, P.O. BOX 320850, ALEXANDRIA, VA, 22320-4850, US

(73) Assignee: TDK CORPORATION, Tokyo (JP)

(21) Appl. No.: 12/114,960

(22) Filed: May 5, 2008

(30) Foreign Application Priority Data
May 16, 2007 (JP) 2007-130890
Jan. 24, 2008 (JP) 2008-014004

(51) Int. Cl. C08K 3/22; B32B 37/00

(52) U.S. Cl. 156/277; 524/435

(57) ABSTRACT

The ferrite paste according to the present invention contains a ferrite powder and an organic vehicle, and the organic vehicle contains an organic solvent and a binder made of a polyvinyl acetal resin and ethyl cellulose. The binder content in the ferrite paste is at least 3.0 weight parts and no more than 5.0 weight parts per 100 weight parts of the ferrite powder, and the polyvinyl acetal resin content is at least 0.5 weight part and no more than 2.0 weight parts per 100 of the weight parts ferrite powder. The ethyl cellulose content is the remainder of subtracting the polyvinyl acetal resin content from the binder content.

### BACKGROUND OF THE INVENTION

1. Field of the Invention

The present invention relates to a ferrite paste and to a method for manufacturing a laminated ceramic component.

2. Related Background Art

In general, laminated ceramic components such as chip inductors, chip beads, chip transformers and LC composite chip components are manufactured by laminating a ferrite layer formed from a ferrite paste and a conductor pattern formed from a conductor paste, then burning this laminate and forming an external electrode thereon.

An example of a laminated ceramic component is the laminated inductance element discussed in Japanese Patent No. 3035479. With this laminated inductance element, a conductor paste and a ferrite paste containing an ethyl cellulose resin as a binder are alternately laminated by printing, and this product is cut to the required size to form a laminate having a coiled conductor in its interior. This laminate is burned and an external electrode is formed to manufacture a laminated inductance element.

### SUMMARY OF THE INVENTION

With the conventional manufacturing method discussed above, however, when the ferrite layer is formed by printing the ferrite paste so as to cover the conductor pattern, the thickness of the ferrite layer located at the sides of the conductor pattern tends to be greater than the thickness of the ferrite layer located directly over the conductor pattern. The thicker portion of the ferrite layer takes longer to dry than the thinner portion, so cracks tend to develop.

This cracking is also attributable to the hard and brittle properties of the ethyl cellulose resin contained as a binder in the ferrite paste. Also, the thicker the conductor paste is, the greater is the difference in thickness of the ferrite layer, so the more likely cracking is to occur.

Also, with the conventional manufacturing method discussed above, debindering during heat treatment (debindering, burning, etc.) of the laminate lowers the strength of the ferrite layer, and shape retention tends to be low. Therefore, as the conductor pattern shrinks, cracks are more likely to develop in the ferrite layer adhering to the conductor.

The present invention was conceived in an effort to solve the above problems, and it is an object thereof to provide a ferrite paste and a method for manufacturing a laminated ceramic component with which there is less cracking of the ferrite layer.

To solve the above problem, the ferrite paste pertaining to the present invention contains a ferrite powder and an organic vehicle, wherein the organic vehicle contains an organic solvent and a binder made of a polyvinyl acetal resin and ethyl cellulose, the binder content is at least 3.0 weight parts and no more than 5.0 weight parts per 100 weight parts of the ferrite powder, the polyvinyl acetal resin content is at least 0.5 weight part and no more than 2.0 weight parts per 100 weight parts of the ferrite powder, and the ethyl cellulose content is the remainder of subtracting the polyvinyl acetal resin content from the binder content.

Also, the method for manufacturing a laminated ceramic component pertaining to the present invention comprises the steps of forming a ferrite green layer from a ferrite paste, drying the ferrite green layer to form a ferrite dry layer, printing the ferrite dry layer with a conductor paste and drying the conductor paste to form a conductor pattern, and alternately laminating other ferrite dry layers and conductor patterns on the ferrite dry layer, on which the conductor pattern has been formed, to form a laminate, wherein the thickness of the conductor pattern before burning is from 7 to 29 μm, the ferrite paste contains a ferrite powder and an organic vehicle, the organic vehicle contains an organic solvent and a binder made of a polyvinyl acetal resin and ethyl cellulose, the binder content is at least 3.0 weight parts and no more than 5.0 weight parts per 100 weight parts of the ferrite powder, the polyvinyl acetal resin content is at least 0.5 weight part and less than 1.0 weight parts per 100 weight parts of the ferrite powder, and the ethyl cellulose content is the remainder of subtracting the polyvinyl acetal resin content from the binder content.

The ferrite green layer and the ferrite dry layer will be collectively referred to as a ferrite layer below.

In addition to the ethyl cellulose used in the past, this ferrite paste contains a polyvinyl acetal resin that is more flexible than ethyl cellulose. Therefore, the ferrite green layer is more flexible, and even if shrinkage stress should be generated in the ferrite green layer during the drying step, cracking in the ferrite layer will be suppressed. Also, even if there should be variance in the degree to which drying proceeds due to a difference in the thickness of the ferrite green layer, cracking in the ferrite layer will be suppressed.

Furthermore, this ferrite paste has a binder that contains a polyvinyl acetal resin whose pyrolysis temperature is higher than that of ethyl cellulose. Therefore, in the heat treatment of the laminate (the debindering step or burning step), the polyvinyl acetal resin will be resistant to decomposition at the temperatures at which the conductor paste shrinks, and a greater proportion of the binder will remain in the ferrite layer. Therefore, the ferrite layer will have better shape retention, and cracking in the ferrite layer will be suppressed.

When the thickness of the conductor pattern before burning is from 7 to 29 μm, then if the polyvinyl acetal resin content is less than 0.5 weight part per 100 weight parts ferrite powder, the flexibility of the ferrite layer will be low, so cracks will tend to develop in the ferrite layer during the drying of the ferrite green layer. Also, during the burning of the laminate, the proportion of the binder remaining in the ferrite layer will tend to decrease at the temperatures at which the conductor pattern shrinks. Consequently, the strength of the ferrite layer will decrease and shape retention will be low, and as the conductor pattern shrinks the ferrite layer adhering to the conductor pattern will be pulled, making it more likely that cracks will develop in the ferrite layer.

On the other hand, when the thickness of the conductor pattern before burning is within the above-mentioned range, if the polyvinyl acetal resin content is at least 1.0 weight part per 100 weight parts ferrite powder, during the burning of the laminate the proportion of binder remaining in the ferrite layer will be too high at the temperatures at which the conductor pattern shrinks, so the binder will suddenly combust at the burning temperature after debindering, making it more likely that cracks will develop in the ferrite layer adhering to the conductor pattern. With the present invention, cracking in the ferrite layer can be kept to an acceptable level by setting the polyvinyl acetal resin content to at least 0.5 weight part and less than 1.0 weight part per 100 weight parts ferrite powder.

Also, the method for manufacturing a laminated ceramic component comprises the steps of forming a ferrite green layer from a ferrite paste, drying the ferrite green layer to form a ferrite dry layer, printing the ferrite dry layer with a conductor paste and drying the conductor paste to form a conductor pattern, and alternately laminating other ferrite dry layers and conductor patterns on the ferrite dry layer, on which the conductor pattern has been formed, to form a laminate, wherein the thickness of the conductor pattern before burning is greater than 29 μm, the ferrite paste contains a ferrite powder and an organic vehicle, the organic vehicle contains an organic solvent and a binder made of a polyvinyl acetal resin and ethyl cellulose, the binder content is at least 3.0 weight parts and no more than 5.0 weight parts per 100 weight parts of the ferrite powder, the polyvinyl acetal resin content is at least 1.0 weight part and no more than 2.0 weight parts per 100 weight parts of the ferrite powder, and the ethyl cellulose content is the remainder of subtracting the polyvinyl acetal resin content from the binder content.

When the thickness of the conductor pattern before burning is greater than 29 μm, then if the polyvinyl acetal resin content is less than 1.0 weight part per 100 weight parts ferrite powder, the ferrite layer will have low flexibility, so cracks will be more likely to develop in the ferrite layer during the drying of the ferrite green layer. Also, during the burning of the laminate, the proportion of binder remaining in the ferrite layer will decrease at the temperatures at which the conductor pattern shrinks, the strength of the ferrite layer will decrease and shape retention will be low, and as the conductor pattern shrinks the ferrite layer adhering to the conductor pattern will be pulled, making it more likely that cracks will develop in the ferrite layer adhering to the conductor pattern.

On the other hand, when the polyvinyl acetal resin content is greater than 2.0 weight parts per 100 weight parts ferrite powder, during the burning of the laminate the proportion of binder remaining in the ferrite layer will be too high at the temperatures at which the conductor pattern shrinks, so the binder will suddenly combust at the burning temperature after debindering, making it more likely that cracks will develop in the ferrite layer adhering to the conductor pattern. With the present invention, cracking in the ferrite layer can be suppressed by setting the polyvinyl acetal resin content to at least 1.0 weight part and no more than 2.0 weight parts per 100 weight parts ferrite powder.

Cracking of the ferrite layer can be suppressed with the present invention.

### BRIEF DESCRIPTION OF THE DRAWINGS

FIG. 1 is a perspective view of a laminated inductor pertaining to a first embodiment of the present invention;

FIG. 2 is a cross sectional view along a line connecting the terminal electrodes of the laminated inductor shown in FIG. 1;

FIG. 3 is a cross sectional view perpendicular to a line connecting the terminal electrodes of the laminated inductor shown in FIG. 1;

FIG. 4 is a table of the relationship between the polyvinyl butyral content in the ferrite and whether or not cracking occurred, when the thickness of the conductor pattern before burning was within the range of the first embodiment;

FIG. 5 is a table of the relationship between the polyvinyl butyral content in the ferrite and whether or not cracking occurred, when the thickness of the conductor pattern before burning was outside the range of the first embodiment;

FIG. 6 is a table of the relationship between the polyvinyl butyral content in the ferrite and whether or not cracking occurred, when the thickness of the conductor pattern before burning was within the range of a second embodiment; and

FIG. 7 is a graph showing the relation between the crack generation rate and the polyvinyl butyral content in the ferrite paste in Working Example 2.

### DESCRIPTION OF THE PREFERRED EMBODIMENTS

Preferred embodiments of the ferrite paste and the method for manufacturing a laminated ceramic component pertaining to the present invention will now be described through reference to the drawings.

### First Embodiment

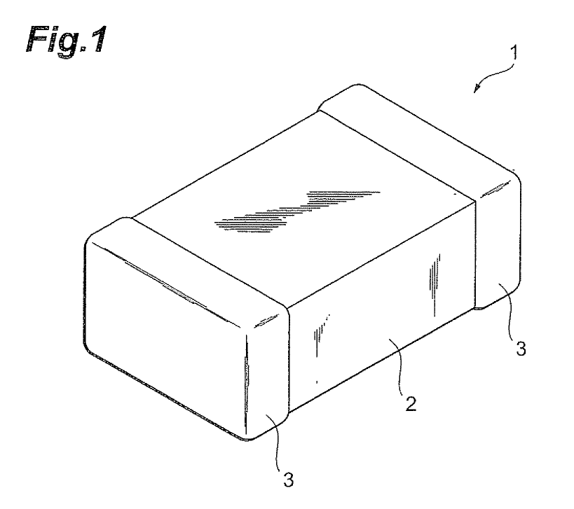

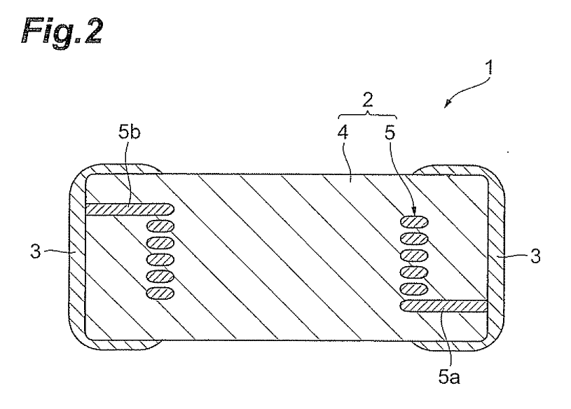

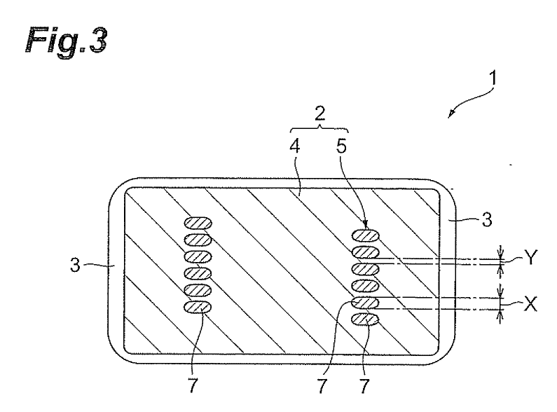

FIG. 1 is an perspective view of the structure of a laminated inductor produced using the method for manufacturing a laminated ceramic component pertaining to the first embodiment of the present invention. FIG. 2 is a cross sectional view along a line connecting the terminal electrodes of the laminated inductor shown in FIG. 1, and FIG. 3 is a cross sectional view perpendicular to that in FIG. 2.

As shown in FIG. 1, a laminated inductor 1 comprises a rectangular parallelepiped element 2 and a pair of terminal electrodes 3 formed so as to cover the two ends in the lengthwise direction of the element 2. As shown in FIGS. 2 and 3, the element 2 comprises a magnetic body laminated part 4 composed of a magnetic material, and a coiled conductor 5 formed inside the magnetic body laminated part 4.

The coiled conductor 5 is composed of a conductive material, and has a substantially semicircular cross sectional shape. Also, as shown in FIG. 2, extraction parts 5a and 5b corresponding to the ends of the coiled conductor 5 are taken off to the ends of the magnetic body laminated part 4 and connected to the terminal electrodes 3. This coiled conductor 5 is configured such that there are a plurality of continuous conductor patterns 7 produced by printing and lamination of a conductor paste.

The number of turns of the coiled conductor 5 is determined according to the DC resistance and inductance values to be obtained. For example, if the DC resistance is 1Ω or less and the inductance is 10 μH, the number of turns is 18.5. The thickness X of the conductor patterns 7 is about 90 to 115% of the distance Y between conductor patterns 7 that are adjacent in the lamination direction.

Next, the method for manufacturing the above-mentioned laminated inductor 1 will be described.

In the manufacture of the laminated inductor 1, first a ferrite paste and a conductor paste are produced. The ferrite paste is produced by combining and kneading a ferrite powder (magnetic powder) and an organic vehicle. The organic vehicle contains an organic solvent and a binder composed of a polyvinyl acetal resin and ethyl cellulose.

The binder content in the ferrite paste is at least 3.0 weight parts and no more than 5.0 weight parts per 100 weight parts ferrite powder. The polyvinyl acetal resin content in the ferrite paste is at least 0.5 weight part and less than 1.0 weight parts per 100 weight parts ferrite powder. The ethyl cellulose content in the ferrite paste is the remainder of subtracting the polyvinyl acetal resin content from the binder content.

A Ni—Cu—Zn—based ferrite powder, Ni—Cu—Zn—Mg-based ferrite powder, Ni—Cu-based ferrite powder, or the like is used as the ferrite powder. In the production of these ferrite powders, it is preferable if a nickel compound whose specific surface area is from 1.0 to 10 m²/g and whose sulfur content, calculated as elemental sulfur, is from 100 to 1000 ppm is used as the raw material.

When a Ni—Cu—Zn—Mg-based ferrite powder is used, the composition thereof is preferably 25 to 52 mol % Fe₂O₃, 0 to 40 mol % ZnO, 0 to 20 mol % CuO, 1 to 65 mol % NiO, and the remainder MgO. If a nickel-based ferrite powder such as this is used, the temperature characteristics will be excellent despite a high density, and furthermore a laminated inductor 1 that can be sintered below the melting point of silver (the material that makes up the coiled conductor 5) can be obtained.

A polyvinyl acetal, polyvinyl butyral, or the like is used as the polyvinyl acetal resin contained in the organic vehicle, but the use of a polyvinyl butyral is preferable. The organic solvent contained in the organic vehicle can be based on an alcohol (such as ethanol, methanol, propanol, butanol, or terpineol), a ketone (such as acetone), a cellosolve (such as methyl cellosolve or ethyl cellosolve), an ester (such as methyl acetate or ethyl acetate), an ether (such as ethyl ether or butyl carbitol), or the like. Just one of these organic solvents may be used, or two or more may be used together.

The above-mentioned ferrite paste may further contain a plasticizer based on a phthalic ester, phosphoric ester, fatty acid ester, glycol derivative, or the like, or a dispersant based on a fatty acid amide, organic phosphoric ester, carboxylic acid, or the like.

The conductor paste is produced, for example, by blending a conductor powder with a binder and an organic solvent in specific ratios and then kneading the mixture. A triple roll, homogenizer, sand mill, or the like is used for this kneading. Silver, a silver alloy, copper, a copper alloy, or the like is usually used as the conductor powder, but silver is preferably used because of its low resistivity. If a silver paste is used as the conductor paste, a laminated inductor with a practical Q value can be obtained.

Next, the ferrite paste is laminated by printing until the specific thickness is reached. More ferrite paste is formed on this laminate to form a ferrite green layer, and this ferrite green layer is then dried to form a ferrite dry layer with a thickness of about 90 to 150 μm.

Next, the ferrite dry layer is printed with the above-mentioned conductor paste, and this conductor paste is dried to form a conductor pattern with a thickness of about 7 to 29 μm. Then, other ferrite dry layers and conductor patterns are alternately laminated by printing on the ferrite dry layer on which the conductor pattern was formed above. On this, ferrite paste is laminated by printing in the specified thickness to form an unburned laminate. In the laminate thus obtained, a spiral laminated coil (the coiled conductor 5) with a specific number of turns (coils) is formed in a ferrite magnetic body (the magnetic body laminated part 4 composed of a plurality of ferrite layers).

Next, the laminate is cut to the specified size. Because the laminate usually has a wafer structure in which a plurality of element units are arranged, a plurality of unburned laminate elements each incorporating a single coiled conductor 5 are formed by cutting the wafer-like laminate to the specified size.

At this point, the wafer-like laminate is cut so that the end faces of the extraction parts 5a and 5b of the coiled conductor 5 will be exposed on two opposite sides of the laminate element. The laminate element thus obtained corresponds to the element 2 in the completed laminated inductor 1 (see FIG. 1). After this, the obtained laminate element is subjected to debindering treatment in the presence of oxygen at 350 to 500° C., for example. The laminate element is then integrally burned for 1 to 2 hours at 850 to 900° C., for example, to obtain the above-mentioned element 2.

Next, in the element 2 obtained by burning, the side faces where the end faces of the extraction parts 5a and 5b of the coiled conductor 5 are exposed are coated with a conductor paste whose main component is silver, and this coating is baked at about 600° C., for example, to form the terminal electrodes 3. After this, the terminal electrodes 3 are usually subjected to electroplating. This electroplating is preferably performed using copper, nickel, and tin; nickel and tin; nickel and gold; nickel and silver; or the like. This completes the laminated inductor 1 pertaining to the first embodiment.

In the first embodiment, the ferrite paste contains as a binder not only the ethyl cellulose that has been used in the past, but also a polyvinyl acetal resin that has higher flexibility than ethyl cellulose. Therefore, flexibility of the ferrite green layer is higher than in the past, so cracking in the ferrite layer can be suppressed even if shrinkage stress occurs in the ferrite green layer during the drying of the ferrite green layer. Also, cracking in the ferrite layer can be suppressed even if there should be variance in the degree to which drying proceeds due to a difference in the thickness of the ferrite green layer.

Also, the polyvinyl acetal resin contained as a binder in the ferrite paste has a higher pyrolysis temperature than ethyl cellulose. Therefore, in the heat treatment of the laminate (the debindering step or burning step), the polyvinyl acetal resin will be resistant to decomposition at the temperatures at which the conductor paste 7 shrinks, and the proportion of binder that remains in the ferrite layer (the magnetic body laminated part 4) will be higher than in the past, so the ferrite layer will have better shape retention. As a result, cracking can be suppressed in the ferrite layer (the magnetic body laminated part 4). Because of this, it is also easy to keep the inductance of the laminated inductor 1 to the desired value.

When the thickness of the conductor pattern before burning is from 7 to 29 μm, then if the polyvinyl acetal resin content in the ferrite paste is less than 0.5 weight part per 100 weight parts ferrite powder, the flexibility of the ferrite layer will be low, so cracks will tend to develop in the ferrite layer during the drying of the ferrite green layer.

Also, during the burning of the laminate, the proportion of binder remaining in the ferrite layer (the magnetic body laminated part 4) will decrease at the temperatures at which the conductor pattern 7 shrinks, the strength of the ferrite layer (the magnetic body laminated part 4) will decrease and shape retention will be low, and the ferrite layer (the magnetic body laminated part 4) adhering to the conductor pattern 7 will be pulled by the conductor pattern 7, making it more likely that cracks will develop in the ferrite layer (the magnetic body laminated part 4) adhering to the conductor pattern 7.

On the other hand, when the thickness of the conductor pattern before burning is within the above-mentioned range, if the polyvinyl acetal resin content is at least 1.0 weight part per 100 weight parts ferrite powder, during the burning of the laminate the proportion of binder remaining in the ferrite layer will be too high at the temperatures at which the conductor pattern shrinks, so the binder will suddenly combust at the burning temperature after debindering, making it more likely that cracks will develop in the portion adhering to the conductor pattern. In view of this, in the first embodiment cracking in the ferrite layer can be suppressed by setting the polyvinyl acetal resin content to at least 0.5 weight part and less than 1.0 weight part per 100 weight parts ferrite powder.

### Second Embodiment

Next, the ferrite paste and the method for manufacturing a laminated ceramic component pertaining to a second preferred embodiment of the present invention will now be described. The laminated inductor pertaining to the second embodiment has the same constitution as the laminated inductor 1 pertaining to the first embodiment.

First a ferrite paste and a conductor paste are produced. The ferrite paste is produced by combining and kneading a ferrite powder (magnetic powder) and an organic vehicle. The organic vehicle contains an organic solvent and a binder composed of a polyvinyl acetal resin and ethyl cellulose.

The binder content in the ferrite paste is at least 3.0 weight parts and no more than 5.0 weight parts per 100 weight parts ferrite powder. The polyvinyl acetal resin content in the ferrite paste is at least 1.0 weight part and no more than 2.0 weight parts per 100 weight parts ferrite powder. The ethyl cellulose content in the ferrite paste is the remainder of subtracting the polyvinyl acetal resin content from the binder content.

A Ni—Cu—Zn-based ferrite powder, Ni—Cu—Zn—Mg-based ferrite powder, Ni—Cu-based ferrite powder, or the like is used as the ferrite powder. In the production of these ferrite powders, it is preferable if a nickel compound whose specific surface area is from 1.0 to 10 m²/g and whose sulfur content, calculated as elemental sulfur, is from 100 to 1000 ppm is used as the raw material.

When a Ni—Cu—Zn—Mg-based ferrite powder is used, the composition thereof is preferably 25 to 52 mol % Fe₂O₃, 0 to 40 mol % ZnO, 0 to 20 mol % CuO, 1 to 65 mol % NiO, and the remainder MgO. If a nickel-based ferrite powder such as this is used, the temperature characteristics will be excellent despite a high density, and furthermore a laminated inductor 1 that can be sintered below the melting point of silver (the material that makes up the coiled conductor 5) can be obtained.

A polyvinyl acetal, polyvinyl butyral, or the like is used as the polyvinyl acetal resin contained in the organic vehicle, but the use of a polyvinyl butyral is preferable. The organic solvent contained in the organic vehicle can be based on an alcohol (such as ethanol, methanol, propanol, butanol, or terpineol), a ketone (such as acetone), a cellosolve (such as methyl cellosolve or ethyl cellosolve), an ester (such as methyl acetate or ethyl acetate), an ether (such as ethyl ether or butyl carbitol), or the like, and just one of these organic solvents may be used, or two or more may be used together.

The above-mentioned ferrite paste may further contain a plasticizer based on a phthalic ester, phosphoric ester, fatty acid ester, glycol derivative, or the like, or a dispersant based on a fatty acid amide, organic phosphoric ester, carboxylic acid, or the like.

The conductor paste is produced, for example, by blending a conductor powder with a binder and an organic solvent in specific ratios and then kneading the mixture. A triple roll, homogenizer, sand mill, or the like is used for this kneading. Silver, a silver alloy, copper, a copper alloy, or the like is usually used as the conductor powder, but silver is preferably used because of its low resistivity. If a silver paste is used as the conductor paste, a laminated inductor with a practical Q value can be obtained.

Next, the above-mentioned ferrite paste is laminated by printing until the specific thickness is reached. More ferrite paste is formed on this laminate to form a ferrite green layer, and this ferrite green layer is then dried to form a ferrite dry layer with a thickness of about 90 to 150 μm.

Next, the ferrite dry layer is printed with the above-mentioned conductor paste, and this conductor paste is dried to form a conductor pattern with a thickness that is greater than 29 μm and no more than 90 μm. Then, other ferrite dry layers and conductor patterns are alternately laminated by printing on the ferrite dry layer on which the conductor pattern was formed above. On this, ferrite paste is laminated by printing in the specified thickness to form an unburned laminate. In the laminate thus obtained, a spiral laminated coil (the coiled conductor 5) with a specific number of turns (coils) is formed in a ferrite magnetic body (the magnetic body laminated part 4 composed of a plurality of ferrite layers).

Next, the laminate is cut to the specified size. Because the laminate usually has a wafer structure in which a plurality of element units are arranged, a plurality of unburned laminate elements each incorporating a single coiled conductor 5 are formed by cutting the wafer-like laminate to the specified size.

At this point, the wafer-like laminate is cut so that the end faces of the extraction parts 5a and 5b of the coiled conductor 5 will be exposed on two opposite sides of the laminate element. The laminate element thus obtained corresponds to the element 2 in the completed laminated inductor 1 (see FIG. 1). After this, the obtained laminate element is subjected to debindering treatment in the presence of oxygen at 350 to 500° C., for example. The laminate element is then integrally burned for 1 to 2 hours at 850 to 900° C., for example, to obtain the above-mentioned element 2.

Next, in the element 2 obtained by burning, the side faces where the end faces of the extraction parts 5a and 5b of the coiled conductor 5 are exposed are coated with a conductor paste whose main component is silver, and this coating is baked at about 600° C., for example, to form the terminal electrodes 3. After this, the terminal electrodes 3 are usually subjected to electroplating. This electroplating is preferably performed using copper, nickel, and tin; nickel and tin; nickel and gold; nickel and silver; or the like. This completes the laminated inductor 1 pertaining to the second embodiment.

In the second embodiment, the ferrite paste contains as a binder not only the ethyl cellulose that has been used in the past, but also a polyvinyl acetal resin that has higher flexibility than ethyl cellulose. Therefore, flexibility of the ferrite green layer is higher than in the past. As a result, cracking in the ferrite layer can be suppressed even if shrinkage stress occurs in the ferrite green layer during the drying of the ferrite green layer. Also, cracking in the ferrite layer can be suppressed even if there should be variance in the degree to which drying proceeds due to a difference in the thickness of the ferrite green layer. Furthermore, with the second embodiment, even when the conductor pattern is thick, cracking attributable to a thickness difference of the ferrite green layer can still be suppressed.

The polyvinyl acetal resin contained as a binder in the ferrite paste pertaining to the second embodiment has a higher pyrolysis temperature than ethyl cellulose. Therefore, in the heat treatment of the laminate (the debindering step or burning step), the polyvinyl acetal resin will be resistant to decomposition at the temperatures at which the conductor paste 7 shrinks, and the proportion of binder that remains in the ferrite layer (the magnetic body laminated part 4) will be higher than in the past, so the ferrite layer will have better shape retention. As a result, cracking can be suppressed in the ferrite layer (the magnetic body laminated part 4). Because of this, it is also easy to keep the inductance of the laminated inductor 1 to the desired value. Since cracking can be suppressed, the inductance of the laminated inductor 1 can be kept to the desired value.

When the polyvinyl acetal resin content in the ferrite paste is less than 1.0 weight part per 100 weight parts ferrite powder, the flexibility of the ferrite layer will be low, making it more likely that cracks will develop in the ferrite layer during the drying of the ferrite green layer. Also, at the temperatures at which the conductor pattern 7 shrinks during the burning of the laminate, the proportion of binder remaining in the ferrite layer (the magnetic body laminated part 4) decreases, the strength of the ferrite layer (the magnetic body laminated part 4) decreases and shape retention becomes lower, and the ferrite layer (the magnetic body laminated part 4) adhering to the conductor pattern 7 is pulled by the conductor pattern 7, making it more likely that cracks will develop in the ferrite layer (the magnetic body laminated part 4) adhering to the conductor pattern 7. On the other hand, if the polyvinyl acetal resin content is greater than 2.0 weight parts per 100 weight parts ferrite powder, during the burning of the laminate the proportion of binder remaining in the ferrite layer will be too high at the temperatures at which the conductor pattern shrinks, so the binder will suddenly combust at the burning temperature after debindering, making it more likely that cracks will develop in the portion adhering to the conductor pattern. In view of this, in the second embodiment cracking in the ferrite layer can be suppressed by setting the polyvinyl acetal resin content to at least 1.0 weight part and no more than 2.0 weight parts per 100 weight parts ferrite powder.

Preferred embodiments of the present invention were described in detail above, but the present invention is not limited to these embodiments. For example, the present invention can also be applied to a sheet method for producing an element by laminating and press-bonding a magnetic body green sheet on which has been formed a conductor pattern constituting a coiled conductor.

The present invention can also be applied to a ceramic paste whose main component is a ceramic powder, such as a dielectrics, instead of a ferrite powder.

### WORKING EXAMPLES

The present invention will now be described in further detail through working examples, but is not limited to or by these examples.

### Working Example 1

### Production of Sample

10,000 samples of a laminated inductor were produced as follows, according to the manufacturing method pertaining to the first embodiment given above. The first step in producing the laminated inductor was to produce a ferrite paste. This ferrite paste was produced by combining an Ni—Cu—Zn—Mg-based ferrite powder with an average particle size of 0.7 μm (used as a magnetic powder) with an organic vehicle and solvent in specific proportions, and then wet mixing the components in a ball mill.

The specific composition of the ferrite powder was 49.0 mol % Fe₂O₃, 19.0 mol % NiO, 11.0 mol % CuO, 20.0 mol % Zn, and the remainder MgO. Polyvinyl butyral (a type of polyvinyl acetal resin) and ethyl cellulose were used as binders contained in the organic vehicle. The binder content in the ferrite paste was varied between 3.0 and 5.00 weight parts per 100 weight parts ferrite powder.

The polyvinyl butyral content in the ferrite paste was varied between 0.00 and 5.00 weight parts per 100 weight parts ferrite powder. The ethyl cellulose content in the ferrite paste was the remainder of subtracting the polyvinyl butyral content from the binder content. Terpineol was used as the organic solvent contained in the organic vehicle.

Next, a conductor paste was produced. This conductor paste was produced by combining silver powder with an average particle size of 0.6 μm with a binder and solvent in specific proportions, and then kneading these components. The above-mentioned ferrite paste was then laminated by printing up to a specific thickness. Then, more ferrite paste was formed on this laminate to form a ferrite green layer, and this ferrite green layer was dried to form a ferrite dry layer with a thickness of 100 μm.

Next, the above-mentioned conductor paste was printed on the ferrite dry layer, and this conductor paste was dried to form a conductor pattern. The thickness of the conductor pattern was varied from 5 to 58 μm. A plurality of other ferrite dry layers and conductor patterns were then alternately laminated on the ferrite dry layer on which the conductor pattern had been formed, to obtain a printed laminate.

Further, ferrite paste was laminated on this by printing in a specific thickness, and an unburned laminate was formed in which a laminated coil (the coiled conductor 5) with 18.5 turns was incorporated. The thickness of the laminate thus obtained was 1.0 mm. This laminate was then cut into a plurality of laminate elements with a length of 1.8 mm and a width of 0.9 mm.

Next, these laminate elements were subjected to debindering treatment in the presence of oxygen at 500° C. After the debindering treatment, the laminate elements were burned for 2 hours at 850° C. Then, the side faces of the burned laminate elements where the end faces of the extraction parts of the coiled conductor 5 were exposed were coated with a conductor paste whose main component was silver, and this coating was baked on at approximately 600° C. The surface of the baked-on silver was then electroplated with copper nickel, and tin to form terminal electrodes. Samples of laminated inductors in 1608 shapes were obtained in the above manner.

[Evaluation]

In the manufacturing process discussed above, the laminate elements were checked for cracks before and after burning. The number of laminate elements confirmed to have cracks was then divided by the total number of obtained laminate elements to find the crack generation rate (unit: %). Similarly, the crack generation rate was also found for burned laminate elements.

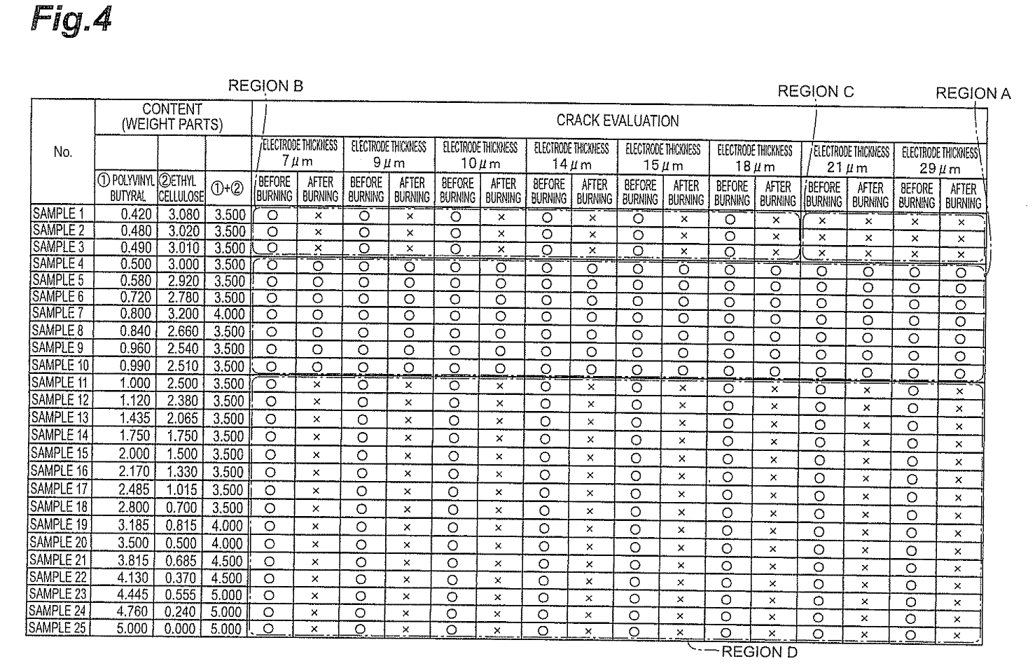

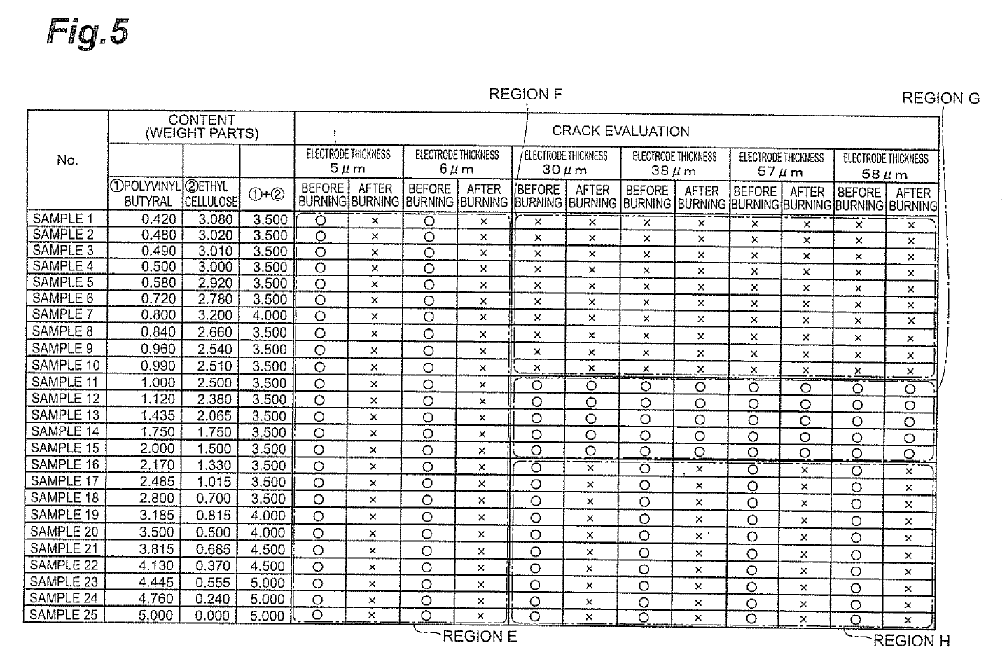

FIGS. 4 and 5 show the inspection results. FIG. 4 shows the data when the thickness of the unburned conductor pattern was within the range of the first embodiment (7 to 29 μm), and FIG. 5 when the thickness of the unburned conductor pattern was below the range of the first embodiment (5 to 6 μm) and over the range of the first embodiment (30 to 58 μm). In these tables, a “◯” means that the crack generation rate was 0%, and a “x” means that the crack generation rate was greater than 0%.

As shown in FIG. 4, when the thickness of the unburned conductor pattern was 7 to 29 μm, and the polyvinyl butyral content was at least 0.5 weight parts and less than 1.0 weight parts per 100 weight parts ferrite powder, no crack generation was observed either before or after burning (region A).

When the thickness of the unburned conductor pattern was 7 to 18 μm, and the polyvinyl butyral content was less than 0.5 weight part per 100 weight parts ferrite powder, crack generation was observed after burning (region B). The reason for this is believed to be that, during the burning of the laminate at the temperatures at which the conductor pattern shrinks, the proportion of binder remaining in the ferrite layer decreases, the strength of the ferrite layer drops and shape retention is low, so cracks develop in the ferrite layer adhering to the conductor pattern.

When the thickness of the unburned conductor pattern was 21 to 29 μm, and the polyvinyl butyral content was less than 0.5 weight part per 100 weight parts ferrite powder, crack generation was observed both before and after burning (region C). The reason for this is believed to be that in addition to the above-mentioned problem with shape retention, the flexibility of the ferrite layer is also low, so cracks develop in the ferrite layer during the drying of the ferrite green layer.

When the thickness of the unburned conductor pattern was 7 to 29 μm, and the polyvinyl butyral content was at least 1.0 weight part per 100 weight parts ferrite powder, crack generation was observed after burning (region D). The reason for this is believed to be that during the burning of the laminate the proportion of binder remaining in the ferrite layer is too high at the temperatures at which the conductor pattern shrinks, and the binder suddenly combusts at the burning temperature after debindering, so cracks develop in the ferrite layer adhering to the drying of the ferrite green layer.

Meanwhile, as shown in FIG. 5, when the thickness of the unburned conductor pattern was less than 7 μm, then no matter what the polyvinyl butyral content was, crack generation was observed after burning (region E). The reason for this is believed to be that the amount of polyvinyl butyral with respect to the thickness of the conductor pattern is too large, so cracks develop for the same reason as in the case of the above-mentioned region D.

Also, when the thickness of the unburned conductor pattern was greater than 29 μm, and the polyvinyl butyral content was less than 1.0 weight part per 100 weight parts ferrite powder, crack generation was observed both before and after burning (region F). The reason for this crack generation is believed to be the same as in the case of region C, but even though the polyvinyl butyral content is higher due to the greater thickness of the conductor pattern, flexibility of the ferrite layer is believed to be insufficient.

When the thickness of the unburned conductor pattern was greater than 29 μm, and the polyvinyl butyral content was at least 1.0 weight part and no more than 2.00 weight parts per 100 weight parts ferrite powder, no crack generation was observed both before and after burning (region G). This region indicates the optimal polyvinyl butyral content when the unburned conductor pattern is thicker than in the first embodiment, although the range is different from that in the first embodiment.

When the thickness of the unburned conductor pattern was greater than 29 μm, and the polyvinyl butyral content was over 2.00 weight parts per 100 weight parts ferrite powder, crack generation was observed after burning (region H). The reason for this crack generation is believed to be the same as in the case of region D.

It was confirmed from the above results that when the thickness of the unburned conductor pattern was from 7 to 29 μm, setting the polyvinyl acetal resin content in the ferrite paste to be at least 0.5 weight part and less than 1.0 weight part per 100 weight parts ferrite powder, and setting the ethyl cellulose content to be the remainder obtained by subtracting the polyvinyl acetal resin content from the binder content, is effective at suppressing cracking.

### Working Example 2

### Sample 3

[Production of Laminated Inductor]

10,000 laminated inductors of sample 3 were produced as follows, according to the manufacturing method pertaining to the second embodiment given above. The first step in producing the laminated inductor was to produce a ferrite paste. This ferrite paste was produced by combining an Ni—Cu—Zn—Mg-based ferrite powder with an average particle size of 0.7 μm (used as a magnetic powder) with an organic vehicle and solvent in specific proportions, and then wet mixing the components in a ball mill.

The specific composition of the ferrite powder was 49.0 mol % Fe₂O₃, 19.0 mol % NiO, 11.0 mol % CuO, 20.0 mol % Zn, and the remainder MgO. Polyvinyl butyral (a type of polyvinyl acetal resin) and ethyl cellulose were used as binders contained in the organic vehicle. The binder content in the ferrite paste was 3.5 weight parts per 100 weight parts ferrite powder.

The polyvinyl butyral content in the ferrite paste was 1.00 weight part per 100 weight parts ferrite powder. The ethyl cellulose content in the ferrite paste was the remainder of subtracting the polyvinyl butyral content from the binder content (2.5 weight parts). Terpineol was used as the organic solvent contained in the organic vehicle.

Also, a conductor paste was produced. This conductor paste was produced by combining silver powder with an average particle size of 0.6 μm with a binder and solvent in specific proportions, and then kneading these components. The above-mentioned ferrite paste was then laminated by printing up to a specific thickness. Then, more ferrite paste was formed on this laminate to form a ferrite green layer, and this ferrite green layer was dried to form a ferrite dry layer with a thickness of 100 μm.

Next, the above-mentioned conductor paste was printed on the ferrite dry layer, and this conductor paste was dried to form a conductor pattern with a thickness of 30 μg/m. A plurality of other ferrite dry layers and conductor patterns were then alternately laminated on the ferrite dry layer on which the conductor pattern had been formed, to obtain a printed laminate.

Further, ferrite paste was laminated on this by printing in a specific thickness, and an unburned laminate was formed in which a laminated coil (the coiled conductor 5) with 18.5 turns was incorporated. The thickness of the laminate thus obtained was 1.0 mm. This laminate was then cut into a plurality of laminate elements with a length of 1.8 mm and a width of 0.9 mm.

Next, these laminate elements were subjected to debindering treatment in the presence of oxygen at 500° C. After the debindering treatment, the laminate elements were burned for 2 hours at 850° C. Then, the side faces of the burned laminate elements where the end faces of the extraction parts of the coiled conductor 5 were exposed were coated with a conductor paste whose main component was silver, and this coating was baked on at approximately 600° C. The surface of the baked-on silver was then electroplated with copper, nickel, and tin to form terminal electrodes. Laminated inductors in 1608 shapes were obtained in the above manner.

[Evaluation]

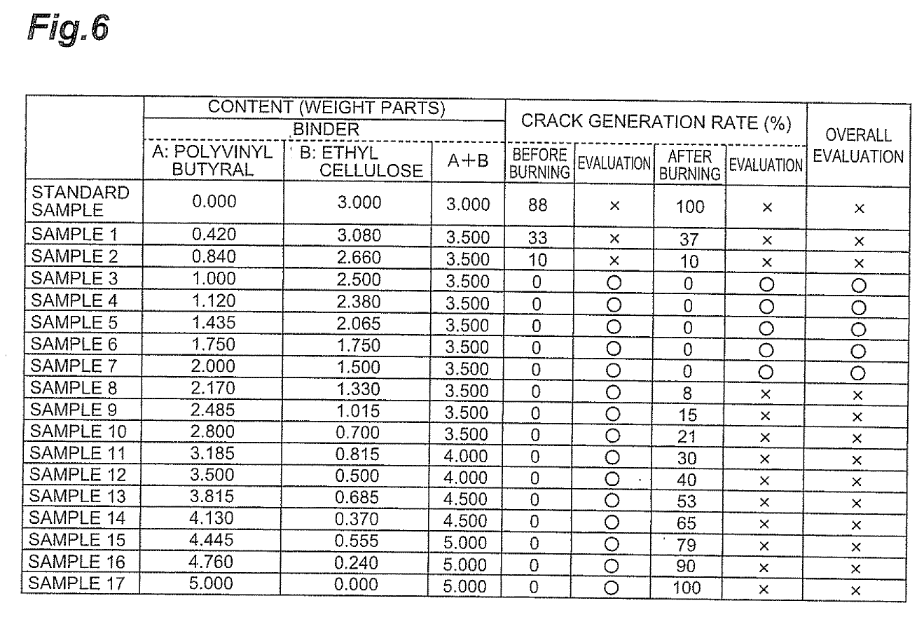

In the manufacturing process discussed above, the laminate elements were checked for cracks before burning. The number of laminate elements confirmed to have cracks was then divided by the total number of obtained laminate elements to find the crack generation rate (unit: %). Similarly, the crack generation rate was also found for burned laminate elements. The results are given in FIG. 6. In FIG. 6, a “◯” means that the crack generation rate was 0%, and a “x” means that the crack generation rate was greater than 0%. The crack generation rate is preferably 0%, so the evaluation is preferably ◯.

Also, when the evaluation was ◯ for the both the crack generation rate before burning and for the crack generation rate after burning, an overall evaluation of ◯ was given. Otherwise, an overall evaluation of x was given. The overall evaluation is preferably ◯. The results are given in FIG. 6.

[Standard Sample and Samples 1, 2, and 4 to 17]

The binder content (unit: weight parts) in the ferrite paste in the production of the standard sample and samples 1, 2, and 4 to 17 were the values given in FIG. 6 per 100 weight parts ferrite powder. The polyvinyl butyral contents (unit: weight parts) in the ferrite paste were the values given in FIG. 6 per 100 weight parts ferrite powder. The ethyl cellulose content in the ferrite paste was the remainder obtained by subtracting the polyvinyl butyral content from the binder content.

The standard sample and samples 1, 2, and 4 to 17 were produced in the same manner as sample 3, except that the binder, polyvinyl butyral, and ethyl cellulose contents had the respective values given in FIG. 6.

The crack generation rate before and after burning was measured for the standard sample and samples 1, 2, and 4 to 17 in the same manner as for sample 3. These results are given in FIG. 6.

As shown in FIG. 6, with samples 3 to 7 the binder content was at least 3.0 weight parts and no more than 5.0 weight parts per 100 weight parts ferrite powder, and the polyvinyl butyral content was at least 1.0 weight part and no more than 2.0 weight parts per 100 weight parts ferrite powder. As a result, with samples 3 to 7, the crack generation rate before and after burning was confirmed to be lower than with the standard sample and samples 1, 2, and 8 to 17.

Meanwhile, with the standard sample and samples 1, 2, and 8 to 17, the binder content was within the range of 3.0 to 5.0 weight parts or less per 100 weight parts ferrite powder, and the polyvinyl butyral content was outside the range of at least 1.0 weight part and no more than 2.0 weight parts per 100 weight parts ferrite powder. As a result, the crack generation rate before and after burning was confirmed to be higher with the standard sample and samples 1 and 2 than with samples 3 to 7. Also, with samples 8 to 17, the crack generation rate after burning was confirmed to be higher than with samples 3 to 7.

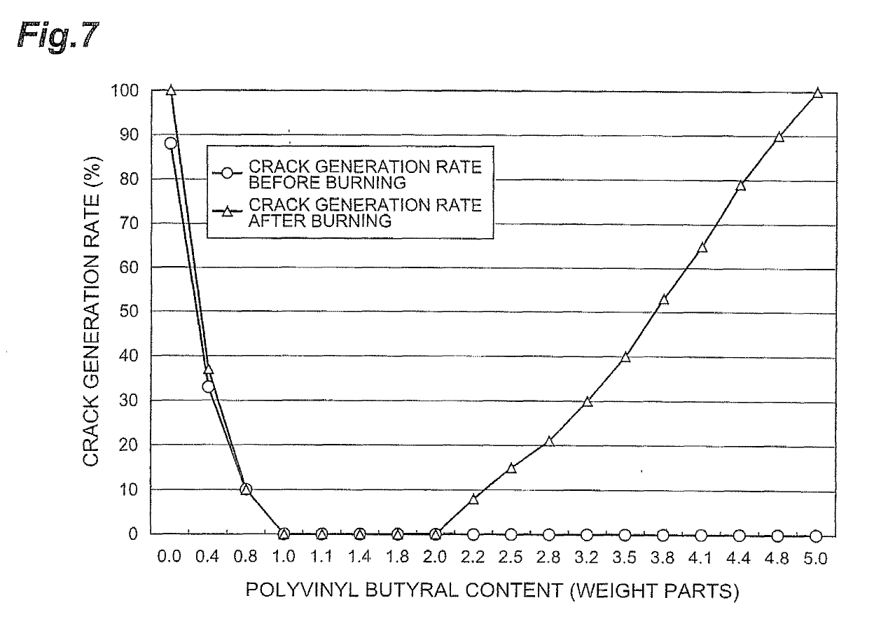

In FIG. 7, the polyvinyl butyral contents in the various ferrite pastes used in the production of the standard sample and samples 1 to 17 are plotted against the corresponding crack generation rates before and after burning.

As shown in FIG. 7, it was confirmed that the crack generation rate after burning was at its lowest when the polyvinyl butyral content in the ferrite paste was within the range of at least 1.0 weight part and no more than 2.0 weight parts per 100 weight parts ferrite powder. It was also confirmed that the more the polyvinyl butyral content is over 2.0 weight parts, the higher is the crack generation rate after burning.

What is claimed is:

1. A ferrite paste, containing a ferrite powder and an organic vehicle, wherein
the organic vehicle contains an organic solvent and a binder made of a polyvinyl acetal resin and ethyl cellulose,
the binder content is at least 3.0 weight parts and no more than 5.0 weight parts per 100 weight parts of the ferrite powder,
the polyvinyl acetal resin content is at least 0.5 weight part and no more than 2.0 weight parts per 100 weight parts of the ferrite powder, and
the ethyl cellulose content is a remainder of subtracting the polyvinyl acetal resin content from the binder content.

2. A method for manufacturing a laminated ceramic component, the method comprising the steps of:
forming a ferrite green layer from a ferrite paste;
drying the ferrite green layer to form a ferrite dry layer;
printing the ferrite dry layer with a conductor paste and drying the conductor paste to form a conductor pattern; and
alternately laminating other ferrite dry layers and conductor patterns on the ferrite dry layer, on which the conductor pattern has been formed, to form a laminate, wherein
the thickness of the conductor pattern before burning is from 7 to 29 μm,
the ferrite paste contains a ferrite powder and an organic vehicle,
the organic vehicle contains an organic solvent and a binder made of a polyvinyl acetal resin and ethyl cellulose,
the binder content is at least 3.0 weight parts and no more than 5.0 weight parts per 100 weight parts of the ferrite powder,
the polyvinyl acetal resin content is at least 0.5 weight part and less than 1.0 weight parts per 100 weight parts of the ferrite powder, and
the ethyl cellulose content is a remainder of subtracting the polyvinyl acetal resin content from the binder content.

3. A method for manufacturing a laminated ceramic component, the method comprising the steps of:
forming a ferrite green layer from a ferrite paste;
drying the ferrite green layer to form a ferrite dry layer;
printing the ferrite dry layer with a conductor paste and drying the conductor paste to form a conductor pattern; and
alternately laminating other ferrite dry layers and conductor patterns on the ferrite dry layer, on which the conductor pattern has been formed, to form a laminate, wherein
the thickness of the conductor pattern before burning is greater than 29 μm,
the ferrite paste contains a ferrite powder and an organic vehicle,
the organic vehicle contains an organic solvent and a binder made of a polyvinyl acetal resin and ethyl cellulose,
the binder content is at least 3.0 weight parts and no more than 5.0 weight parts per 100 weight parts of the ferrite powder,
the polyvinyl acetal resin content is at least 1.0 weight part and no more than 2.0 weight parts per 100 weight parts of the ferrite powder, and
the ethyl cellulose content is a remainder of subtracting the polyvinyl acetal resin content from the binder content.
